(19) United States
(12) Patent Application Publication
(10) Pub. No.: US 2010/0146178 A1
(43) Pub. Date: Jun. 10, 2010

(54) NEGATION-BASED FIXED-PRIORITY ARBITER

(76) Inventor: Daaven Shawn Messinger, Austin, TX (US)

Correspondence Address: Daaven S. Messinger, 2302 Valley High Circle, Austin, TX, 78744, US

(21) Appl. No.: 12/630,840

(22) Filed: Dec. 3, 2009

Related U.S. Application Data
(60) Provisional application No. 61/120,047, filed on Dec. 4, 2008.

(51) Int. Cl. G06F 13/362

(52) U.S. Cl. 710/114

(57) ABSTRACT

A device includes an M-bit input request for service bus, a NEGATE component that may perform a negation operation on the M-bit input bus, an AND component that may perform a Boolean AND operation on the M-bit input signal and the negated input, and an M-bit 1-HOT grant output bus that indicates which request for service is being granted.

### CROSS-REFERENCE TO RELATED APPLICATIONS

This application claims the benefit of U.S. Provisional Application Ser. No. 61/120,047 entitled “NEGATION BASED FIXED-PRIORITY ARBITER,” filed on Dec. 4, 2008, which is incorporated herein by reference.

### BACKGROUND INFORMATION

1. Field of the Invention

Implementations described herein relate generally to an arbiter used in electrical computer systems and digital data processing systems. More particularly, an implementation described herein may relate to a method and apparatus that includes a fixed-priority arbiter using negation logic in Field Programmable Gate Arrays (FPGAs) and other integrated circuits.

2. Discussion of the Related Art

One building block needed in logic design of FPGAs and other integrated circuits may be an arbiter. The simplest arbiter may include a fixed-priority arbiter, which has “M” requests for service and “M” grant signals. The request REQ[0] may designate the highest priority, followed by REQ[1], followed by REQ[2] and so on. At most, one grant may be asserted, indicating service is being granted to a particular master device that is requesting service. If more than one request is asserted at the same time, then the request with the highest priority may be granted and the lower priority request(s) may be ignored.

Merit of the arbiter may be determined by one or more metrics, which may include gate count, minimum cycle time, and power consumption. Because FPGAs may have many limitations, logic blocks may need to be specifically designed for FPGAs to obtain highest merit. Implementations described herein may provide exceptional merit for FPGAs, as well as other integrated circuits.

### SUMMARY OF THE INVENTION

According to one aspect, a device may include a M-bit input request for service bus, a NEGATE component that is to perform a negation operation on the M-bit input bus, an AND component that is to perform a Boolean AND operation on the M-bit input signal and the negated input, and a M-bit 1-HOT grant output bus that is to indicate a particular request for service, from the one or more requests for service, is being granted.

Additionally, the NEGATE component may be to subtract the M-bit request for service input signal from zero. A carry out from the NEGATE component may also generate the grant summary output indicating a request of service is being granted.

Additionally, the device may include a 1-HOT to binary encoder to generate a N-bit binary-encoded grant output signal. N may be determined by rounding, to positive infinity, a logarithm of M base 2. Combinatorial signals 1-HOT grant output, a binary-encoded grant output, and a grant summary output may be synchronized to a device clock input, resulting in a synchronized 1-HOT grant output, synchronized binary-encoded grant output, and synchronized grant summary output, respectfully.

According to another aspect, a method, performed by an electronic device, may include receiving a M-bit signal that includes one or more requests for service; negating the M-bit input signal to generate a negated input signal; combining the M-bit input signal and the negated input signal using an AND operation to generate a combined signal; and generating a 1-HOT encoded M-bit output signal that indicates a particular request for service, from the one or more requests for service, is being granted, the generating being based on the combined signal.

The fixed-priority arbiter may be utilized within one or more FPGAs, application specific integrated circuits (ASICs), microprocessors, microcontrollers, digital signal processors, network processors, or any other integrated circuit or combinations thereof.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 illustrates a device according to an implementation described herein;

FIG. 2 lists Java code relating number of arbiter input bits “M” to number of encoded output bits “N”;

FIG. 3 lists Verilog code indicating 130 ENCODER function; and

FIG. 4 lists VHDL code showing the operation of a fixed-priority arbiter.

### DETAILED DESCRIPTION

The following detailed description refers to the accompanying drawings. The same reference numbers in different drawings identify the same or similar elements. Also, the following detailed description does not limit the invention.

Exemplary implementations described herein may relate to a fixed-priority arbiter with high merit for FPGAs and other integrated circuits. The implementations described herein, including any logic circuit, may be modeled, generated, or both, by a computer based on a description of the hardware, expressed in the syntax and the semantics of a hardware description language (HDL). Such HDL descriptions are often stored on a computer readable medium. A computer-readable medium may be defined as a physical or logical memory device. A logical memory device may include memory space within a single physical memory device or spread across multiple physical memory devices. Applicable HDLs include those at the layout, circuit netlist, register transfer, and/or schematic capture levels. Examples of HDLs include, but are not limited to: GDS II and OASIS (layout level); various SPICE languages, and IBIS (circuit netlist level); Verilog, and VHDL (register transfer level); and Virtuoso custom design language and Design Architecture-IC custom design language (schematic capture level). HDL descriptions may also be used for a variety of purposes, including but not limited to layout, behavior, logic and circuit design verification, modeling, and/or simulation.

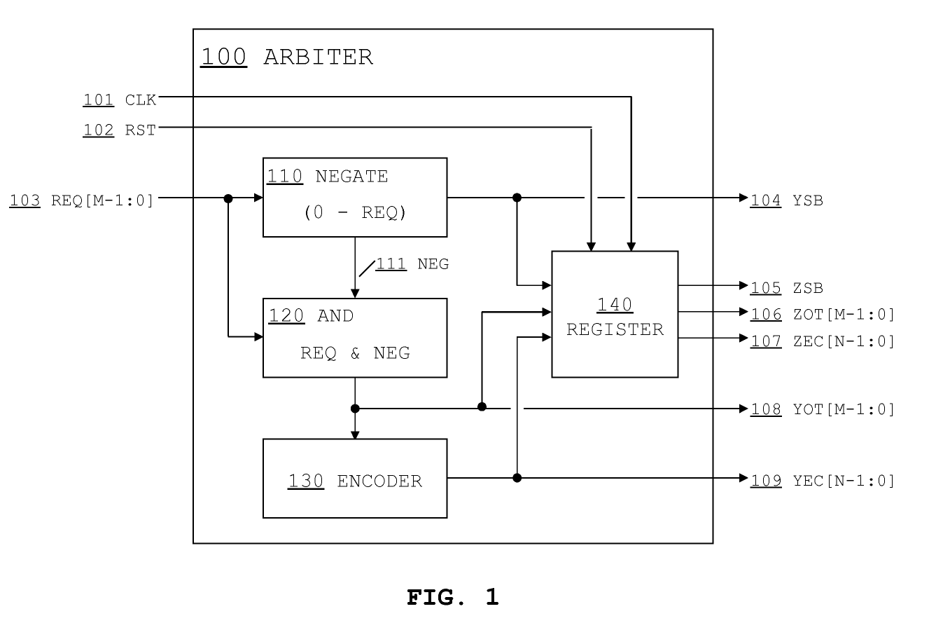

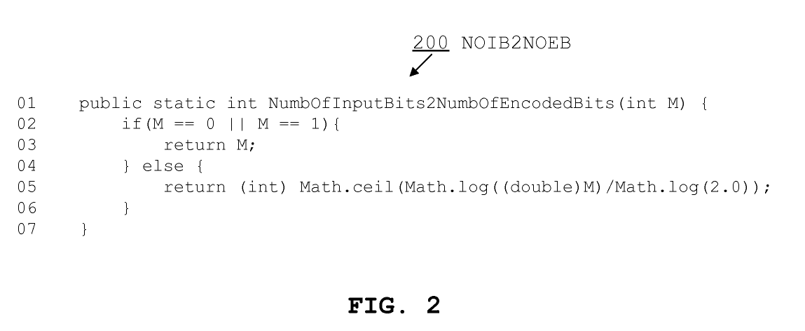

FIG. 1 illustrates 100 ARBITER which may include a 110 NEGATE block component, an 120 AND block component, an 130 ENCODER block component, and a 140 REGISTER block component. The 100 ARBITER may include a plurality of inputs and outputs. Inputs and outputs of 100 ARBITER, as illustrated in FIG. 1, are provided in Table 1. The number of request input bits “M” (103 REQ[M-1:0]) may be related to the number of encoded output bits “N” (109 YEC[N-1:0]) by a simple relation, which is explained below with reference to FIG. 2.

TABLE 1

| LINE | SIGNAL | I/O Type | Description |
|---|---|---|---|
| 1 | CLK | Input | Clock |
| 2 | RST | Input | Reset |
| 3 | REQ[M-1:0] | Input | Requests from masters |
| 4 | YOT[M-1:0] | Output | Expanded grant (combinatorial) |
| 5 | YSB | Output | Output strobe (combinatorial) |
| 6 | YEC[N-1:0] | Output | Encoded grant (combinatorial) |
| 7 | ZOT[M-1:0] | Output | Expanded grant (synchronous) |
| 8 | ZSB | Output | Output strobe (synchronous) |
| 9 | ZEC[N-1:0] | Output | Encoded grant (synchronous) |

The 110 NEGATE block component may receive requests for service on the 103 REQ bus and perform the negation operation by setting the output 111 NEG to (0−REQ). The 110 NEGATE block may also generate a carry out and be connected to 104 YSB to indicate a request for service is being honored. 110 NEGATE may use a standard method of negation by adding zero to the ones'-complement of 103 REQ plus 1.

The 120 AND block component may set the output 108 YOT to the Boolean AND of the request for service input bus (103 REQ) and the 110 NEGATE output bus (111 NEG). The 108 YOT bus may be 1-HOT encoded, meaning at most one YOT output bit may be set to a one at any time.

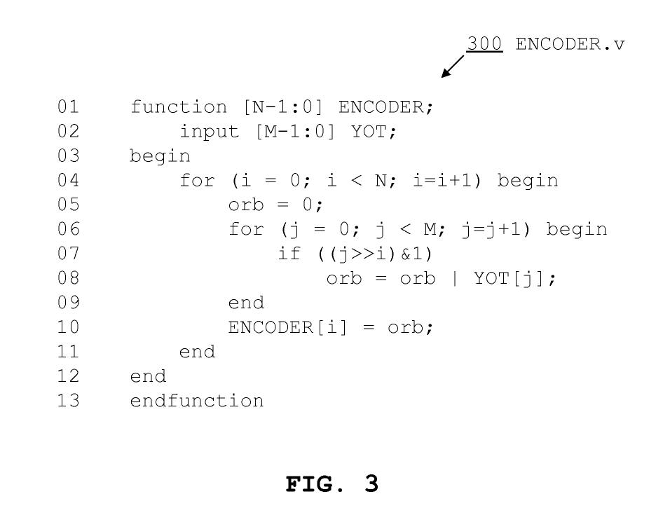

The 130 ENCODER block component may take the 1-HOT 108 YOT grant bus and generate the 109 YEC binary-encoded grant output bus. FIG. 3, which is described below, lists exemplary Verilog code for the 130 ENCODER block that may be used to encode the 1-of-M YOT[M-1:0] bits into the 109 YEC[N-1:0] output bits. As a result of 108 YOT being 1-HOT encoded, the 130 ENCODER logic may be optimized.

The 140 REGISTER block component may be used to generate synchronous outputs 105 ZSB, 106 ZOT[M-1:0] and 107 ZEC[N-1:0] from the combinatorial output signals 104 YSB, 108 YOT[M-1:0] and 109 YEC[N-1:0], respectively. The 101 CLK signal may be the synchronizing input signal and 102 RST may be the reset signal that may set the REGISTER state to an initial value.

The 100 ARBITER may operate using a negation rule. For example, 100 ARBITER may scan the input 103 REQ from right to left. The output bit 111 NEG[i]=103 REQ[i] until REQ[i]==1. Then the bits to the left may be set to NEG[i]=˜REQ[i]. After YOT=(0−REQ) & REQ is applied, only the right-most REQ “one” bit may be set, resulting in a fixed-priority arbiter. The following is used as an example:

| | |
|---|---|
| 1 | REQ = 01011010 |
| 2 | NEG = (0-REQ) = 10100110 |
| 3 | YOT = (0-REQ) & REQ = 00000010 |

Because fast negation may be supported in many FPGAs, the FPGA implementation may perform well in all three merit categories. In other integrated circuits, fast-carry look-ahead subtraction (i.e., for 0−REQ) may be used to optimize the circuit, resulting in implementation of an arbiter with high merit.

Although FIG. 1 shows exemplary components of 100 ARBITER, in other implementations, 100 ARBITER may contain fewer, different, additional, or differently arranged components than depicted in FIG. 1. In still other implementations, one or more components of 100 ARBITER may perform one or more other tasks described as being performed by one or more other components of 100 ARBITER.

FIG. 2 illustrates exemplary 200 Java code according to an implementation described herein. The exemplary 200 Java code of FIG. 2 may relate the number of arbiter input bits M to number of encoded output bits N. Line 05 returns the value of N by rounding to positive infinity, the logarithm of M base 2.

FIG. 3 illustrates exemplary 300 Verilog code for the 130 ENCODER block component. 300 Verilog code may be used to encode the 1-of-M YOT[M-1:0] input bits into the 109 YEC[N-1:0] output bits. The “for loop” code in Line 04 scans the YEC output and the code in Line 06 scans the YOT output from least-significant to most-significant. The code in Lines 05 and 08 performs a Boolean OR of the YOT input bits, conditioned by the code expression in Line 07. The code in Line 10 returns the final N result.

While FIGS. 2 and 3 illustrate exemplary code that may be used to implement aspects of an arbiter as described herein, in other implementations, the code of FIGS. 2 and 3 may include fewer, different, additional, or differently arranged instructions. Furthermore, while FIG. 2 illustrates Java code and FIG. 3 illustrates Verilog code, any programming language or hardware description language may be used to implement the code, instructions, and/or hardware descriptions illustrated in FIGS. 2 and 3.

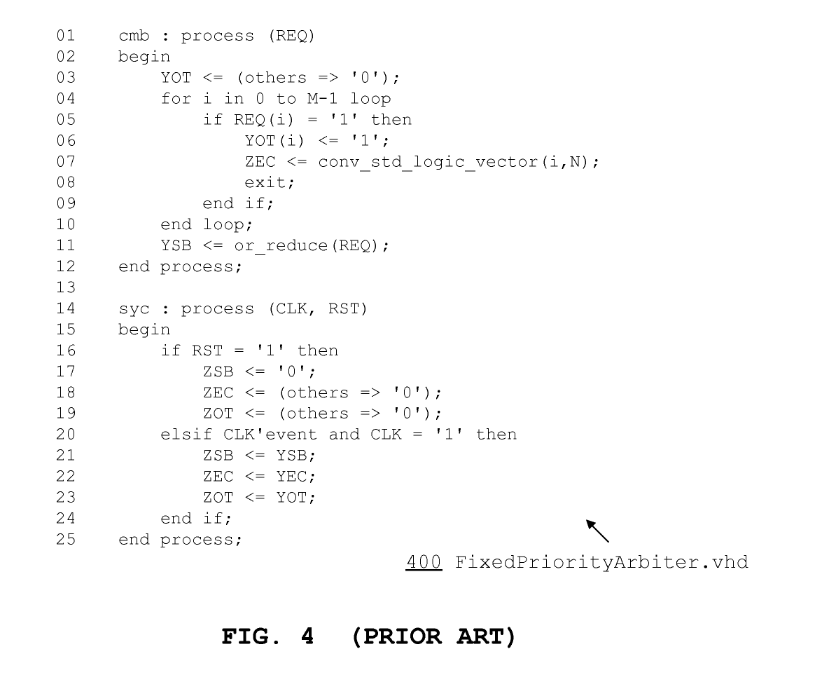

FIG. 4 illustrates the operation of a fixed-priority arbiter (prior art). The code in lines 01-12 implements a combinatorial section which asserts a YOT(i) bit to a one (Line 06) by scanning for REQ(i)==1 from least-significant to most-significant (Line 05). The scanning is stopped once a REQ bit is found to be a one (Line 08). The code in Line 11 generates a YSB grant summary output. In addition, the code in Line 07 sets the binary-encoded value YEC. The code in lines 14-25 implements a synchronous section which generates ZSB (Line 21), ZEC (Line 22) and ZOT (Line 23) synchronized to the CLK signal (Line 20).

The 100 ARBITER uses a different structure to obtain a similar, albeit more efficient, fixed-priority arbiter operation. Instead of scanning a REQ input, the 110 NEGATE and the 120 AND block may be used to generate a YOT output directly. The 130 ENCODER block may then be used to generate a YEC output, replacing the code in Line 07. The 110 NEGATE block carry output may generate a YSB output, which replaces the code in Line 11. The 140 REGISTER block of FIG. 1 may be implemented by code that is similar to the code in Lines 14-25, in the synchronous section of the code of FIG. 4.

It will be appreciated by one skilled in the art that additional functionality may be implemented in the present invention such as input masking, parking and locking. Input masking may include selectively enabling only a subset of requests at a particular time. Parking may include asserting a particular grant when no requests are pending. Locking may include grants that are held over multiple cycles as determined by a primary input locking bus.

### CONCLUSION

The foregoing description provides illustration and description, but is not intended to be exhaustive or to limit the invention to the precise form disclosed. Modifications and variations are possible in light of the above teachings or may be acquired from practice of the invention.

Still further, aspects have been mainly described in the context of a FPGA. As discussed above, the device and methods described herein may be used with any type of device that includes service requests. It should also be understood that particular devices discussed above are exemplary only and other devices may be used in alternative implementations to generate the desired information.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the description. In fact, many of these features may be combined in ways not specifically recited in the claims and/or disclosed in the specification.

No element, act, or instruction used in the description of the present application should be construed as critical or essential to the description unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device comprising:
an input bus that includes M bits, where the input bus is to receive an M-bit signal that includes one or more requests for service;
a NEGATE component that is to perform a negation operation on the M-bit input signal and to output a negated input signal;
an AND component that is to perform a Boolean AND operation on the M-bit input signal and the negated input signal; and
an output bus that includes M bits, where the output bus is to generate an 1-HOT encoded M-bit output signal that indicates a particular request for service, from the one or more requests for service, is being granted.

2. The device of claim 1, where M includes a positive integer.

3. The device of claim 1, further comprising:
a grant summary output that indicates a request of service is being granted.

4. The device of claim 1, where the NEGATE component is further to perform an arithmetic operation that includes subtracting the M-bit request for service input signal from zero.

5. The device of claim 4, where the negate component further includes a carry output and where the negate component may generate the grant summary output.

6. The device of claim 1, further comprising:
an encoder component that is to receive the 1-HOT M-bit grant output signal and generate a N-bit binary-encoded output signal that indicates which request for service included in the input signal is being granted.

7. The device of claim 6, where the encoder component is to determine N based on rounding to positive infinity, the logarithm of M base 2.

8. The device of claim 1, further comprising:
a register component, comprising:
a first input signal to receive the M-bit 1-HOT grant output signal;
a second input signal to receive the N-bit binary-encoded grant output signal;
a third input signal to receive the grant summary output signal; and
a first output signal to generate a synchronized M-bit 1-HOT grant output signal;
a second output signal to generate a synchronized N-bit binary-encoded grant output signal; and
a third output signal to generate a synchronized grant summary output signal.

9. The device of claim 8, further comprising a clock input and where the register component is to synchronize to the clock input, the N-bit 1-HOT grant output signal, the binary-encoded grant output signal, and the grant summary output signal.

10. A method, performed by an electronic device, comprising:
receiving an M-bit signal that includes one or more requests for service;
negating the M-bit input signal to generate a negated input signal;
combining the M-bit input signal and the negated input signal using an AND operation to generate a combined signal; and
generating a 1-HOT encoded M-bit output signal that indicates a particular request for service, from the one or more requests for service, is being granted, the generating being based on the combined signal.
